(19) United States
(12) Patent Application Publication
(10) Pub. No.: US 2014/0327355 A1
(43) Pub. Date: Nov. 6, 2014

(54) LED PAR LAMP IN A WIRELESS NETWORK ENVIRONMENT

(71) Applicant: Technical Consumer Products, Inc., Aurora, OH (US)

(72) Inventors: Timothy CHEN, Aurora, OH (US); George J. Uhler, Wadsworth, OH (US)

(73) Assignee: Technical Consumer Products, Inc., Aurora, OH (US)

(21) Appl. No.: 13/887,282

(22) Filed: May 4, 2013

(51) Int. Cl. H05B 37/02; F21K 99/00

(52) U.S. Cl. CPC H05B 37/0272; F21K 9/50
USPC 315/34

(57) ABSTRACT

A flat LED PAR lamp having an antenna secured to the exterior parabolic wall of the glass reflector for use in a wireless network. The interior wall is coated with an aluminized reflective coating that shields the antenna from the internally radiated noise. The aluminized parabolic reflector, together with its companion flat clear lens, is made using a lead-free glass to improve the lumen preservation over the life of the lamp. An efficient LED lamp array is used as the primary source of illumination within the parabolic reflector. Mounted in the base of the LED PAR lamp is the wireless communication and control.

### REFERENCE TO PREVIOUSLY FILED APPLICATIONS

Applicants claim the benefit of Provisional Patent Application Ser. No. 61/643,835, filed May 7, 2012, Titled, EMBEDDED NETWORKING ANTENNA FOR SMART LIGHTING, which Application is incorporated herein by reference.

### FIELD OF INVENTION

The present invention relates to light emitting diode (LED) lamps, and more particularly to an LED PAR lamp that is structured to provide for the transmission and reception of a wireless signal; hence the lamp is enabled remotely to transmit and/or receive a wireless signal to or from the equipment of a wireless network by means of the lamp, a hand held remote and a wired network equipment. Additionally, a shielded antenna mounted to the exterior surface of a glass reflector of the lamp extends the range of coverage of the reception area.

### BACKGROUND OF THE INVENTION

In recent years, wireless network communications technology has gradually shifted away from the use of wired type of network systems. Through the use of a wireless network, everyone can easily acquire instant information by utilizing devices such as a mobile phone, a personal digital assistant, a notebook computer, and the like. Therefore, informational electrical appliances are an important area of operations for wireless transmission.

As a result of the various wireless network communication protocols, different baud rates and transmission ranges are independently suitable as primary application areas for home or business, regardless of whether the application area of the wireless network is a general household or a large business.

Accordingly, in an environment implementing wireless network communication, a small base platform constitutes an indispensable relay device that is utilized to connect between a wireless network transmission/reception system and the wireless network reception/transmission devices, such as is mounted in the base of the newly designed Smart LED PAR lamp. Hence, the small base platform directly affects the efficiency of signal transmission.

Therefore, a majority of the newly designed wireless network reception devices have installed a fixed length extended antenna on the body of the device in order to enhance the transmission and reception effectiveness of a wireless signal. However, obstruction of peripheral equipment results when an antenna connected to the transceiver device is too long; and too short an antenna length is also incapable of normal signal transmission and/or reception. Particularly, in a practical environment, difficulties arise in locating a suitable position to place the small base transceiving platform, which can result in lower than expected operation quality of the wireless network.

### DESCRIPTION OF THE PRIOR ART

The following prior art discloses the various aspects in the design and use of lamps having an antenna mounted to the exterior of the reflecting apparatuses and other related devices.

U.S. Pat. No. 6,734,642, granted May 11, 2004, to Giorgio Reverberi, discloses a monitoring and management system for the lamps of a lighting network comprising a device, associated with each lamp of the network, provided with means for measuring the characteristic operating parameters of the lamp, at least one microprocessor for processing said measured parameters, and a transmitter/receiver for transmitting said data which are received by a central unit; said transmitter/receiver is of radio wave type and is arranged to receive the parameters measured by the successive devices and to transmit them, together with the parameters measured for the lamp with which it is associated, to at least the transmitter/receiver of that device associated with the preceding lamp.

U.S. Pat. No. 6,888,315, granted May 3, 2005, to Po-Sen Hsiao, discloses a lamp, comprising a base of the lamp configured with a wireless transmission component. The wireless transmission component is adapted to having an electric circuit enabled to implement wireless signal reception and/or transmission. A power cord is connected to a power supply circuit of the electric circuit. An aerial circuit of the electric circuit is connected to a metal stand of the lamp or to a metal frame of a lampshade, thereby enabling a connection to be made between a signal transmission port of the wireless transmission component and wired network equipment. Furthermore, the lamp is structured to implement wireless signal transmission through linking the wireless transmission component with equipment having a wireless network card.

U.S. Pat. No. 7,123,140, granted Oct. 17, 2006, to A. Denes, discloses a wireless network for remotely controlling at least one lamp includes a first radio transceiver associated with the at least one lamp and a second radio transceiver. The first radio transceiver further includes a circuit for controlling the at least one lamp as a function of a message repeated by a second radio transceiver.

U.S. Pat. No. 7,321,302, granted Jan. 22, 2008, to G. P. Beghelli, discloses a central test radio frequency system for emergency lighting comprising a set of emergency light units or emergency lamps (L1-L13) and a remote control unit (CU) that manages the system's functionality, wherein each of said emergency lamps (L1-L13) has a radio transmitter-receiver (MR), which is able to communicate to each of said emergency lamps and to the remote control unit (CU) via radio signals.

U.S. Pat. No. 8,111,018, granted Feb. 7, 2012, Tung-Hsin You, discloses an application infrastructure for constructing illumination equipments with a transmission function includes at least one lamp reporting device for reporting a lamp condition, at least one lamp detection and transmission module with a two-way communication function, at least one message transmission and receiving module coupled to a control system, and a main system. Through a built-in wireless network or a power line network function of the illumination equipments, data can be transmitted among nodes of a mixed routing by indoor lighting having a transmission function and outdoor road lamps having a transmission function, without the need of building a basic network structure. A special network structure connecting the nodes to form lines and planes constitutes the application platform for constructing the illumination equipments with a two-way transmission function.

Each of the above referenced prior art disclose individual improvements in the efficiency of lamps as used in a wireless network community. However, none of the prior art teaches the merits of the composite summation of individual efficiencies that make up a single lamp, nor of the losses associated with the transmission and reception of wireless signals. It is therefore the intent of this newly designed LED PAR lamp to reduce the attendant losses incrementally over each element comprising a PAR lamp.

What is needed is an energy efficient PAR lamp using a lead-free glass to improve the lumen preservation over the life of the bulb, using an efficient LED lamp as the primary source of illumination within the parabolic reflector, using a flat sealed lead-free glass face to minimize the losses experienced during transmission and reception, and a sealed rotatable interlocking device joining the parabolic reflector to the base of the lamp. In this regard, the present invention fulfills this need.

It is therefore an object of the present invention to provide an efficient LED PAR lamp having a wireless network control circuit mounted in the base of the lamp.

It is another object of the present invention to provide an efficient LED PAR lamp having a parabolic reflector made of a clear lead-free glass.

It is still another object of the present invention to provide an efficient LED PAR lamp having a compatibly formed flat sealed lead-free glass face, more commonly referred to as a lens.

It is still yet another object of the present invention to provide an efficient LED PAR lamp whose interior surface is coated with an aluminized reflective coating.

Another object of the present invention to provide an efficient LED PAR lamp having an antenna mounted to the exterior of the parabolic reflector that is effectively shielded from the radiation emanating from the operating components located in the interior of the base of the lamp.

It is a final object of the present invention to provide a low-cost LED PAR lamp having a control device comprising a transceiver/receiver, a microprocessor, a communication decoder, a power control driver and a power output stage, mounted in the base of said lamp.

These as well as other objects and advantages of the present invention will be better understood and appreciated upon reading the following summary of the invention as well as the detailed description of the preferred embodiment when taken in conjunction with the accompanying drawings.

### SUMMARY OF THE INVENTION

The present invention relates to an efficient LED PAR lamp, designed for use in a wireless network, and is comprised of the following major assemblies: a parabolic aluminized reflector, engaged by a flat faced lens, containing an at least one LED light source and a base whose housing contains a newly designed ballast and a wireless network control circuitry.

The parabolic aluminized reflector, mated by a flat-faced disc-shaped lens, is made of a clear lead-free glass to preserve the lumen intensity over the entire life of the lamp. More importantly, the flat-faced disc-shaped lens is made of a clear lead-free glass to preserve the luminosity. A waterproof adhesive and sealant is used to join the flat-faced lens to the parabolic reflector.

An efficient LED lamp array is the primary source of illumination found centrally within the parabolic reflector at it focal point at the base of the parabolic reflector. The preferable ranges for the lamp wattages are 14, 16 and 23 watts.

An antenna circuit is connected to a transceiver circuit located in the base of the lamp. A base platform is configured with functionality for transmitting a wireless signal, enabling the lamp to implement wireless signal transmission to equipment having wireless network communication by the means; of the antenna mounted preferably on the outer lamp parabolic surface and being connected to the wireless network system in the base.

To enable a further understanding of the said objectives and the technological methods of the invention herein, the brief description of the drawings below is followed by the detailed description of the preferred embodiments.

### BRIEF DESCRIPTION OF THE DRAWINGS

The present invention is pictorially illustrated in the accompanying drawings that are attached herein.

FIG. 1 is a side elevational view, in partial section of the preferred embodiment of the efficient LED PAR lamp, having the Wireless Network Antenna mounted securely to the outer portion of the glass reflector.

FIG. 2 is a side elevational view, in partial section, showing the ballast and control circuit board positioned against the bottom opening of the base of the reflector.

FIG. 3 is a block diagram illustrating the operation of the present invention.

### DETAILED DESCRIPTION OF THE INVENTION

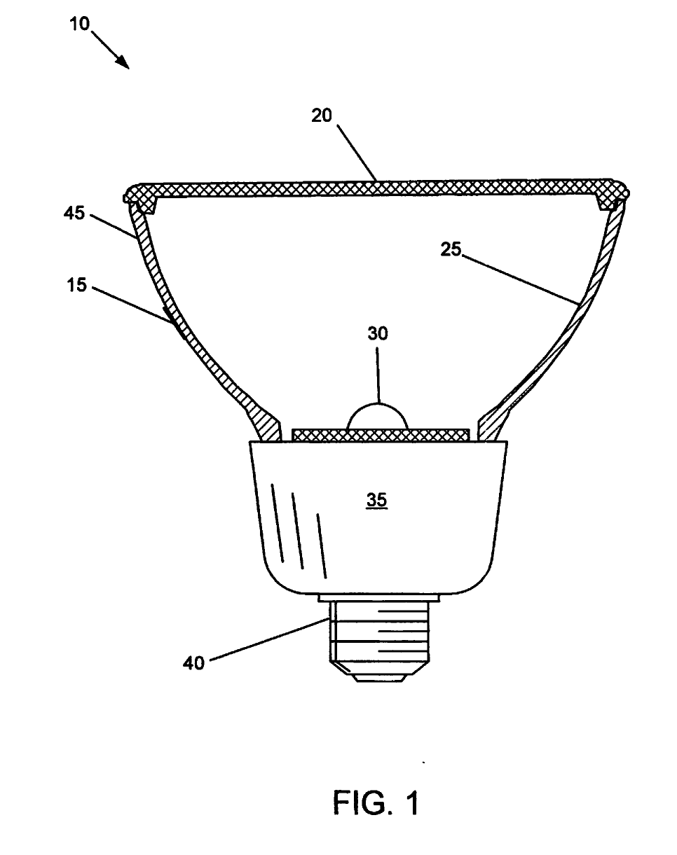

FIG. 1 illustrates the flat LED PAR lamp 10 having a parabolic reflector 15, where at the large opening of the reflector, it receives a flat lens 20. The reflector 45 and flat lens 20 are made of a clear, lead-free glass. More preferably, the reflector 45 is constructed of a non-conductive plastic material. The interior surface of the reflector 45 is covered with a highly reflective aluminized coating 25, directing the light emitted from the area of the focal point outwardly, through the transparent lens 20, forming a concentrated beam of light. One or more arrays of LEDs 30 provide an efficient source of light.

The flat lens 20 is attached to the inner recessed edge of the reflector by using a waterproof adhesive sealant or bonding agent.

As an alternative to a standard halogen PAR lamp, the present invention accommodates three presently available sized lamps: 14 watts, 16 watts and 23 watts which provide illumination intensities equivalent to 30-watt to 90-watt halogen lamps, respectively.

The lamp base housing 35 is made preferably of a plastic material, one that is sufficiently stable and will not crack or shatter when mishandled; even a small opening in the base can permit fluids to gain access to the printed circuit board 55, thereby creating a potential shock or safety hazard. The lamp base housing 35 and the candelabra screw base 40 are molded into a one-piece assembly, thereby reducing the complexity in assembly and manufacturing.

The wireless network antenna 15 is mounted to the glass parabolic reflector 45 and is completely isolated and shielded by the aluminized reflective inner surface 25.

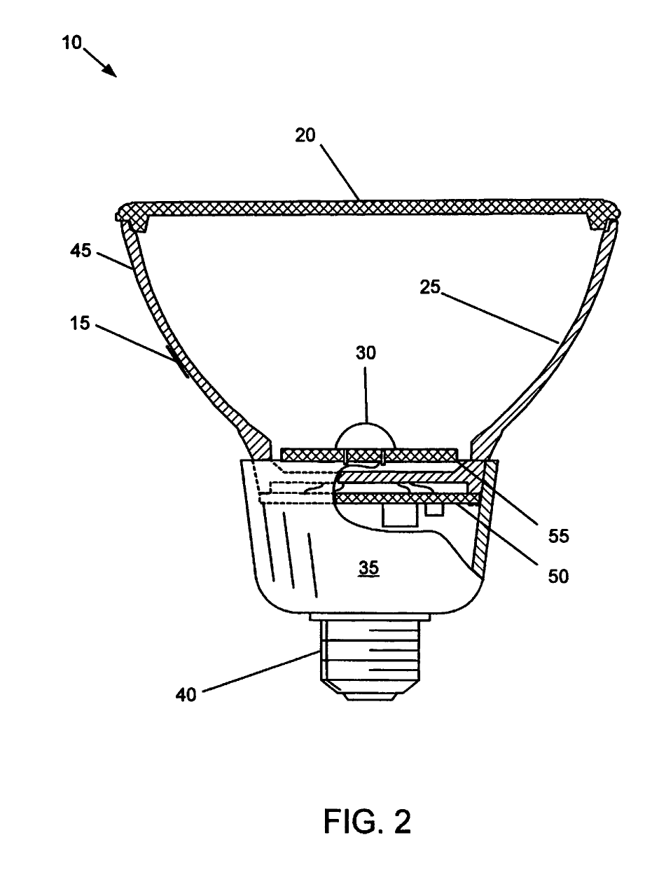

FIG. 2 best illustrates the securement of the LED 30 into the bottom of the parabolic reflector 45. Each leg of the LED lamp is inserted into two receiving holes in the bottom of the reflector and cemented in place using a suitable bonding agent. Each leg has two flexible wires running from the lamp electrodes connecting into the lamp driver printed circuit board 55. The lamp driver and control printed circuit board and assembly are then cemented to the rim at the base of the parabolic reflector.

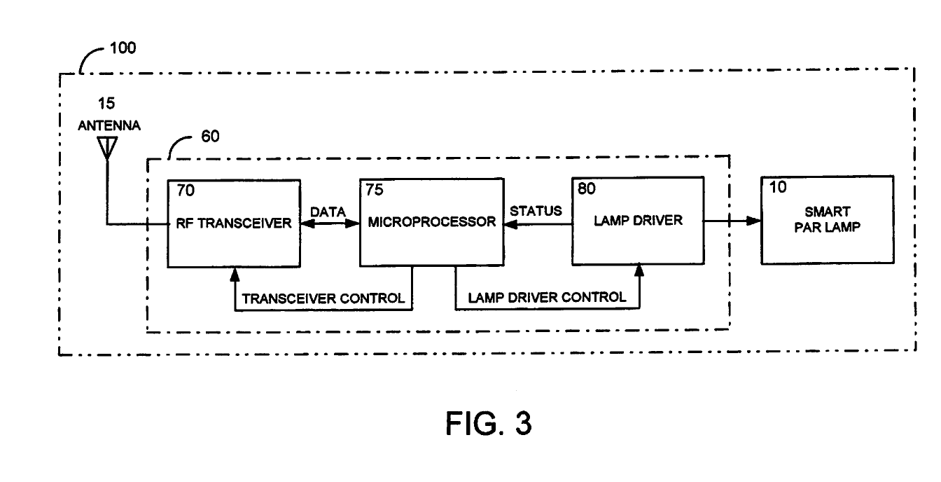

Turning now to FIG. 3, there is shown the block diagram 100 for operation of the wireless communication and control for LED par lamps of the present invention. RF signals are received at the input of transceiver 70 via antenna 15. The wireless communication and control of the newly invented wireless Smart PAR lamp 60 is comprised of an antenna 15, transceiver/receiver 70, a microprocessor with memory 75, and lamp driver 80.

RF transceiver/receiver 70 receives and/or transmits data from a member of the wireless network. When the RF transceiver 70 is operating in the receiving mode, its output subsequently passes the demodulated data on to the microprocessor 75.

When the RF transceiver/receiver 70 is transmitting data to a member of the wireless network; it modulates the data from the microprocessor 75, and passes the data on via antenna 15 to other members of the wireless network.

The microprocessor 75 controls the RF operation of the transceiver/receiver 70 to efficiently provide communications to other members of the wireless network, as well as to control the operation of the lamp driver 80.

Furthermore, when the Smart PAR lamp 10 is to be put in specific use, the microprocessor 75 can be programmed with the user-oriented applications to control the interface and operation of typical Smart PAR lamp 10. More specifically, some of the applications may be to turn a specified lamp on or off at a specified time, or to remotely control the dimming of a specified lamp or group of lamps, or should a lamp in a serially connected string fail and become open-circuited, a controlled signal can be sent to bypass the failed open-circuit lamp by shorting it out with an equivalent load resistor to return the rest of the serially connected lamps to their normal operation. Such applications are typically endless; such as in safety lighting applications for vehicles and helicopters at hospitals, street lighting needs, including instant emergency lighting at known accident areas.

In summary, the present invention is not limited to the examples and to the embodiment described and represented, but is open to numerous variations that become available to those persons who are skilled in the art.

We claim:

1) An LED par lamp having a lamp base with a wireless network control circuit in the base.

2) An LED par lamp as defined in claim 1, further comprising a parabolic reflector made of a clear lead-free glass.

3) An LED par lamp as defined in claim 1, further comprising a parabolic reflector formed of non-conductive plastic.

4) An LED par lamp as defined in claim 3, further comprising compatibly formed flat face lens that is sealed in a large opening of the parabolic reflector.

5) An LED par lamp as defined in claim 4, wherein an interior surface of the parabolic reflector is coated with an aluminized reflective coating.

6) An LED par lamp as defined in claim 5, further comprising an antenna for receiving and transmitting communications.

7) An LED par lamp as defined in claim 6, wherein the antenna is mounted upon a non-conductive component of the lamp.

8) An LED par lamp as defined in claim 7, wherein the antenna is mounted to an exterior surface of the parabolic reflector.

9) An LED par lamp as defined in claim 8, wherein the antenna is electronically isolated and shielded from radiation emanating from operating components within the lamp base by the aluminized reflective interior surface coating.

10) An LED par lamp as defined in claim 9, the lamp base further comprising a housing.

11) An LED par lamp as defined in claim 10, wherein the housing includes a candelabra screw base, the housing and the candelabra screw base formed in a molded one-piece assembly.

12) An LED par lamp as defined in claim 11, the control circuit comprising a transceiver/receiver that provides data to a microprocessor with memory, a communication decoder, a lamp driver printed circuit board and a power output stage.

13) An LED par lamp as defined in claim 12, wherein the LED includes two legs each leg inserted into a respective receiving hole in the base and bonded to stabilize the legs; each leg having a pair of flexible wires that connect a pair of lamp electrodes to the lamp driver printed circuit board.

14) An LED par lamp as defined in claim 13, wherein the transceiver/receiver, microprocessor, communication decoder and lamp driver printed circuit board are fixed to an upper rim of the lamp base housing.

15) An LED par lamp as defined in claim 14, wherein the lamp is an element of a wireless network comprising a plurality of LED par lamps.

16) An LED par lamp as defined in claim 15, wherein the microprocessor modulates data that is passed on via the antenna to other lamps in the wireless network.

17) An LED par lamp as defined in claim 16, wherein the microprocessor is programmed to turn on or off a lamp at a specified time.

18) An LED par lamp as defined in claim 17, wherein the microprocessor is programmed to remotely control dimming of a specific lamp or a group of lamps in the wireless network.

19) An LED par lamp as defined in claim 18, wherein the microprocessor is programmed for an event wherein a serially connected string fails and becomes open-circuited, to emit a signal for bypass of the failed lamp by shorting it out with an equivalent load resistor for return of the functional lamps to normal operation.
